(19) United States
(12) Patent Application Publication
(10) Pub. No.: US 2006/0154619 A1
(43) Pub. Date: Jul. 13, 2006

(54) Semi-automatic swing device for a mobile terminal

(75) Inventors: Eun-Deok Bae, Suwon-si (KR); Dong-Ok Kwak, Suwon-si (KR); Yong-Jin Lee, Yongin-si (KR); Hyun-Gue Park, Seoul (KR)

Correspondence Address: DILWORTH & BARRESE, LLP, 333 EARLE OVINGTON BLVD., UNIONDALE, NY, 11553, US

(73) Assignee: Samsung Electronics Co., Ltd., Suwon-si (KR)

(21) Appl. No.: 11/262,860

(22) Filed: Oct. 31, 2005

(30) Foreign Application Priority Data
Jan. 11, 2005 (KR) 2005-2514

(51) Int. Cl. H04B 1/38

(52) U.S. Cl. 455/90.3

(57) ABSTRACT

A semi-automatic swing device for a swing-type mobile terminal including a body, and a swing housing slidably mounted to an upper surface of the body, in which the swing housing slides in parallel on the upper surface the body. The semi-automatic swing device includes a base plate, a swing plate slidably and rotatably mounted to the base plate while being opposite to the base plate, and a semi-automatic power drive interposed between the base plate. The semi-automatic power drive applies a moment force to be rotated in a counterclockwise direction to the swing plate if the semi-automatic power drive pivots up to a desired angle, and applies a moment force to be rotated in a clockwise direction to the swing plate if the semi-automatic power drive pivots above a desired angle.

### PRIORITY

This application claims priority to an application entitled “Semi-Automatic Swing Device for Mobile Terminal” filed in the Korean Industrial Property Office on Jan. 11, 2005 and assigned Serial No. 2005-2514, the content of which is hereby incorporated by reference.

### BACKGROUND OF THE INVENTION

1. Field of the Invention

The present invention relates generally to mobile terminals for digital communication such as cellular phones, PDAs (personal digital assistants), HHPs (hand held phones), camera phones, game phones, internet phones, messenger phones, etc., and more particularly, to a semi-automatic swing device for a mobile terminal.

2. Description of the Related Art

In general, mobile terminals are electronic devices capable of being carried by a user to wirelessly communicate with others. Accordingly, such mobile terminals are generally compact, thin, and lightweight, in order to facilitate terminal portability. In addition, mobile terminals usually incorporate multimedia technologies to provide various other functions.

There are several types of mobile terminals, which are commonly classified by their appearances, e.g., a bar-type mobile terminal, a flip-type mobile terminal, and a folder-type mobile terminal. The bar-type mobile terminal has a single housing formed in the shape of a bar. The flip-type mobile terminal has a bar-shaped housing and a flip pivotally coupled to the housing by means of a hinge. The folder-type mobile terminal has a bar-shaped housing and a folder that is rotatably coupled to the housing by means of a hinge, to be folded to or unfolded from the housing.

There are also different types of mobile terminals that are classified according to a carrying position or carrying fashion, e.g., a necklace-type mobile terminal and a wrist-type mobile terminal. As their names indicate, the necklace-type terminal is put on the neck of a user with a string, and the wrist-type mobile terminal is worn on a wrist of the user.

In addition, some mobile terminals are classified according to an operation manner of a folder, e.g., a swing-type mobile terminal, a sliding-type mobile terminal, and a swivel-type mobile terminal. The swing-type mobile terminal has two housings that are rotatably coupled to each other, with one being opposite to the other. The sliding-type mobile terminal has two housings that are slidably coupled to each other, wherein one housing can slide along a longitudinal direction of the terminal. The swivel-type mobile terminal has two housings that swivel open and closed with respect to each other.

In addition, the mobile terminal may be classified according to a combination of the sliding type and the swing type, or a combination of the sliding type and the swivel type.

The above-described mobile terminals are known by those skilled in the art.

However, the swing-type mobile terminal has a drawback in that a swing housing must be manually pivoted. That is, a user must forcibly swing the swing housing at a certain angle.

### SUMMARY OF THE INVENTION

Accordingly, the present invention has been designed to solve the above—and other problems contained in the prior art. An object of the present invention is to provide a semi-automatic swing device for a mobile terminal capable of easily swinging a swing housing with simple operation.

Another object of the present invention is to provide a semi-automatic swing device for a mobile terminal, which is easily assembled due to a semi-automatic drive utilizing a spring module having a simple structure.

Still another object of the present invention is to provide a semi-automatic swing device for a slim mobile terminal.

In order to accomplish the above and other objects, there is provided a semi-automatic swing device for a swing-type mobile terminal including a body, and a swing housing slidably that is mounted to an upper surface of the body, in which the swing housing slides in parallel on the upper surface the body while being opposite to the upper surface. The semi-automatic swing device includes: a base plate; a swing plate slidably and rotatably mounted to the base plate while being opposite to the base plate; and a semi-automatic power drive interposed between the base plate, in which the semi-automatic power drive applies a moment force to be rotated in a counterclockwise direction to the swing plate if the semi-automatic power drive pivots up to a desired angle, and applies a moment force to be rotated in a clockwise direction to the swing plate, if the semi-automatic power drive pivots above a desired angle.

### BRIEF DESCRIPTION OF THE DRAWINGS

The above and other objects, features, and advantages of the present invention will be more apparent from the following detailed description taken in conjunction with the accompanying drawings, in which:

FIG. 1 is a perspective view illustrating a mobile terminal having a semi-automatic swing device according to a preferred embodiment of the present invention;

FIG. 2 is a perspective view illustrating a mobile terminal having a semi-automatic swing device according to a preferred embodiment of the present invention, depicting a state in which a swing housing is slid in a certain distance;

FIG. 3 is a perspective view illustrating a mobile terminal having a semi-automatic swing device according to a preferred embodiment of the present invention, depicting a state in which a swing housing pivots at an angle of about 90°;

FIG. 4 is a perspective view illustrating a semi-automatic swing device according to a preferred embodiment of the present invention;

FIG. 5 is a plan view illustrating the semi-automatic swing device of FIG. 4;

FIG. 6 is a cross-sectional view illustrating a spring module used in a semi-automatic swing device according to a preferred embodiment of the present invention;

FIG. 7 is a perspective view illustrating a semi-automatic swing drive mounted to a base plate;

FIGS. 8A through 8C are schematic views illustrating an operation principle of a semi-automatic swing device according to the present invention, in which FIG. 8A illustrates the semi-automatic swing device pivoting at an angle of 0, FIG. 8B illustrates the semi-automatic swing device pivoting at an angle of 45°, and FIG. 8C illustrates the semi-automatic swing device pivoting at an angle of 90°; and

FIG. 9 is a graph illustrating a moment principle of a semi-automatic swing device according to the present invention.

### DETAILED DESCRIPTION OF THE PREFERRED EMBODIMENT

Preferred embodiments of the present invention will be described in detail hereafter with reference to the accompanying drawings. In the following description, the same elements will be designated by the same reference numerals although they are illustrated in different drawings.

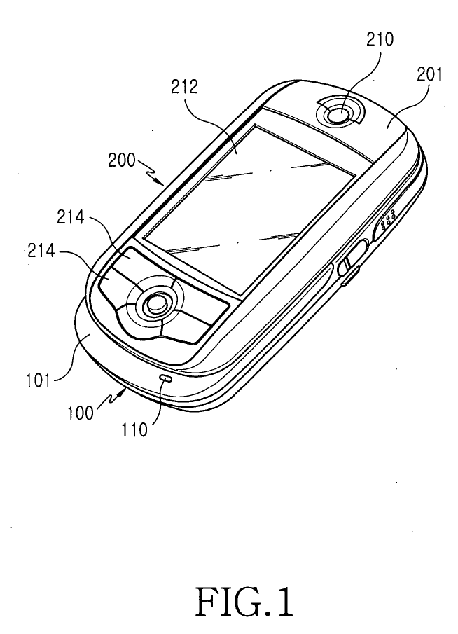

As illustrated in FIGS. 1 through 3, a mobile terminal having a semi-automatic swing device according to the present invention includes a body 100, and a swing housing 200, which is slidably mounted to an upper surface 101 of the body. The swing housing 200 slides in parallel on the upper surface the body, while being opposite to the upper surface, and rotates around a hinge shaft A.

Referring to FIG. 1, the body 100 and the swing housing 200 have a different length such that a length of the body 100 is larger than that of the swing housing 200. The body 100 includes a microphone 110 that is preferably placed at one lowermost corner of the upper surface 101. The microphone 110 is constantly opened regardless of sliding and swing movement of the swing housing 200. Also, the swing housing 200 is provided on an upper surface 201 with at least one key 210, a display 212 adjacent to the single key 210, and a second key pad 214 arranged with a plurality of keys adjacent to the display 212.

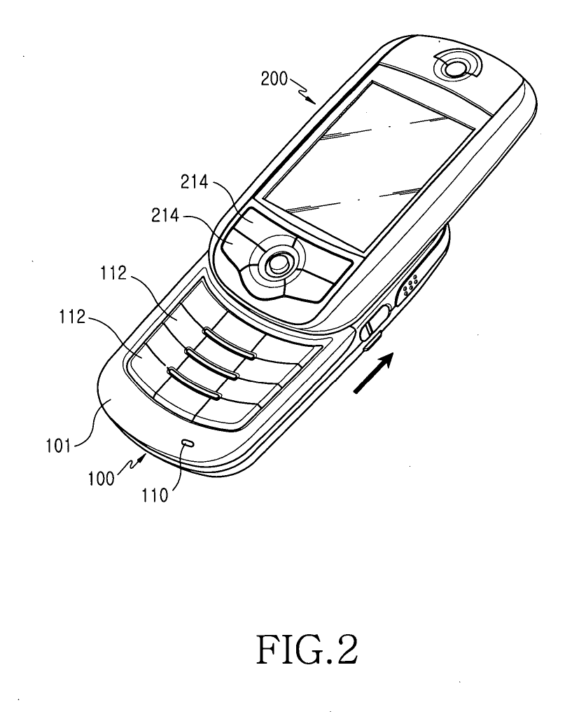

FIG. 2 is a perspective view depicting a state in which the swing housing 200 is fully slid open on the upper surface 101 of the body 100 in a longitudinal direction of the terminal. Referring to FIG. 2, the upper surface 101 of the body 100 is provided with a first keypad 112 having a plurality of keys. For example, the first keypad 112 has a matrix array of 3×4, and is placed adjacent to the microphone 110. The first keypad 112 is opened or closed by sliding the swing housing 200. More specifically, the first keypad 112 is hidden when the swing housing 200 closed on the body 100, and the first keypad 112 is fully opened when the swing housing 200 fully opened on the body 100.

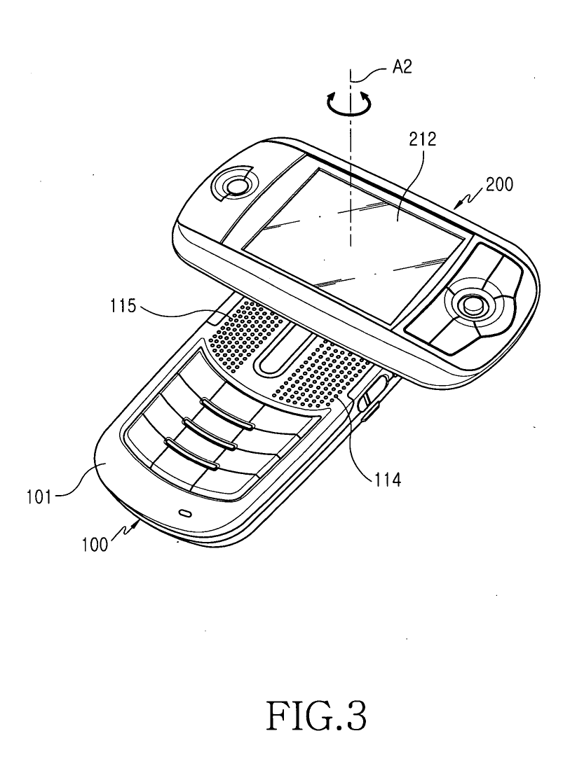

FIG. 3 is a perspective view illustrating the swing housing 200 in a fully pivoted position. Referring to FIG. 3, the body 100 includes a pair of loudspeakers 114 and 115, which are capable of producing a stereo sound, at a desired position on the upper surface 101. The loudspeakers 114 and 115 are opened or closed by swing the swing housing 200. More specifically, the loudspeakers 114 and 115 are hidden when the swing housing 200 not pivoted on the body 100, and the loudspeakers 114 and 115 are fully opened when the swing housing 200 fully pivoted on the body 100.

As illustrated in FIG. 3, the display 212 is preferably adjacent to the loudspeakers 114 and 115. Further, the loudspeakers 114 and 115 preferably produce the stereo sound in a direction perpendicular to the upper surface 101.

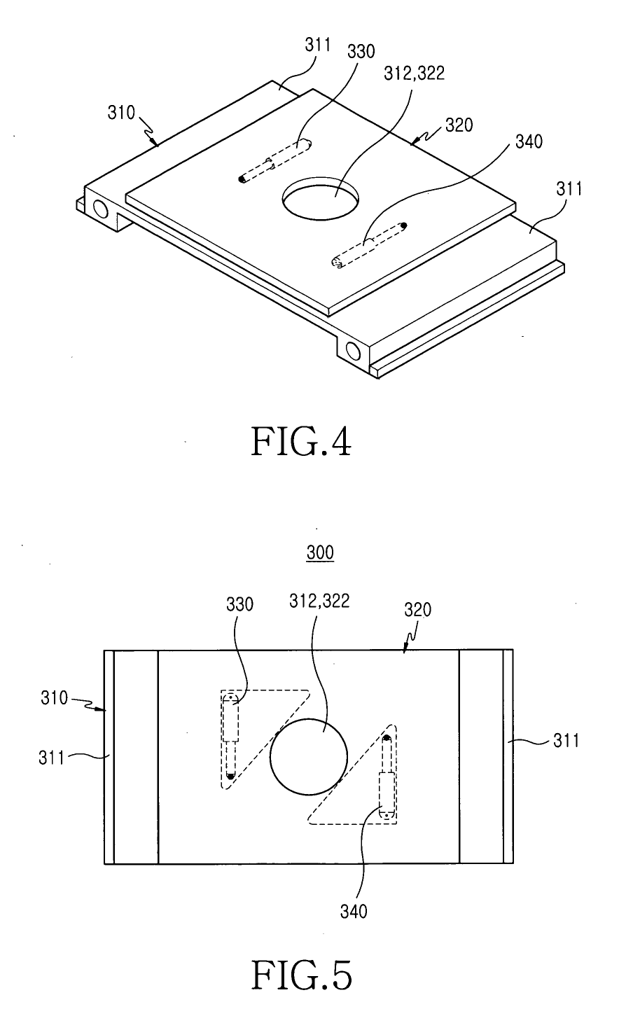

Referring to FIGS. 4 and 5, a semi-automatic swing device according to the present invention includes a base plate 310, a swing plate 320 that is positioned on top of the base plate 310 and swings within a range of a desired angle, and a semi-automatic power drive 330 for applying a moment force to be rotated in a counterclockwise direction to the swing plate 320 when the semi-automatic power drive 330 pivots up to a desired angle and applying a moment force to be rotated in a clockwise direction to the swing plate 320 when the semi-automatic power drive 330 pivots above a desired angle.

The base plate 310 and the swing plate 320 are restrained to be rotated to each other, and are provided with circular openings 312 and 322 at a center of the plates, respectively. A flexible circuit (not shown) is placed in the openings 312 and 322.

The semi-automatic power drive 330 and another semi-automatic power drive 340 are symmetrically placed to each other around the openings 312 and 322. The semi-automatic power drive 340 has the same structure as that of the semi-automatic power drive 330, the description of which will be omitted.

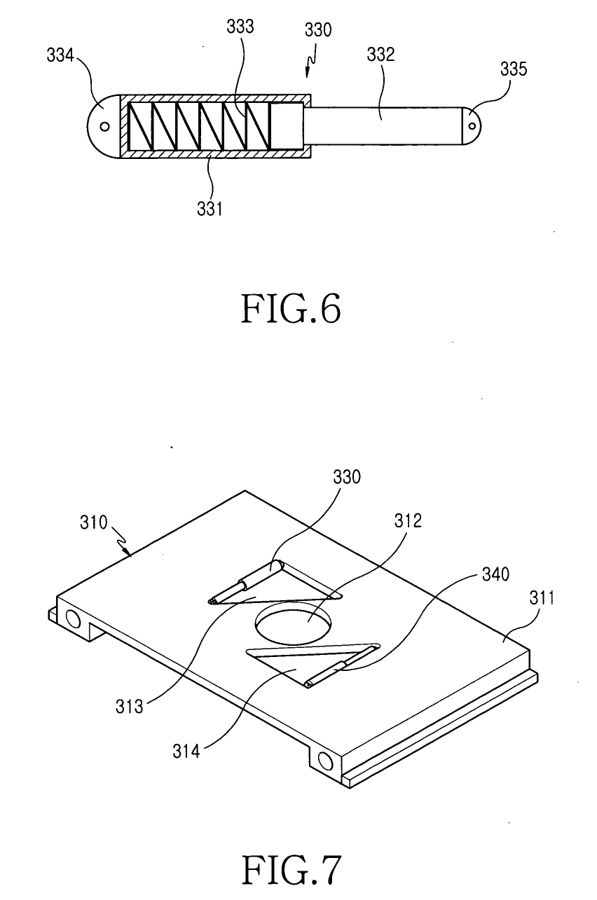

Referring to FIGS. 5 and 6, the semi-automatic power drive 330 is placed in a space between the base plate 310 and the swing plate 320. More specifically, one end 334 of the semi-automatic power drive 330 is rotatably fitted in the base plate 310, and the other end 335 is rotatably fitted in the swing plate 320. Accordingly, the semi-automatic power drive 330 is mounted in a reversed shape to the semi-automatic power drive 340.

The semi-automatic power drive 330 is formed in straight shape, and preferably includes a spring module having a coil spring 333. Preferably, the coil spring 333 is a compression coil spring. The power source of the semi-automatic power drive is not limited to the coil spring, and a torsion spring or pneumatic module (such as cylinder or piston) may be utilized.

More specifically, the semi-automatic power drive 330 includes a hollow portion 331 of an invariable length in which the compression coil spring 333 is fitted along a longitudinal direction, and a rod member 332 of a variable length fitted in the hollow portion 331. and the rod member 332 expanded or retracted by the compression coil spring 333. The compression coil spring 333 of the semi-automatic power drive 330 is linearly expanded or retracted in the hollow portion 331. Preferably, the hollow portion 331 and the rod member 332 are made of metal.

Preferably, a pair of the semi-automatic power drives 330 and 340 are provided in a space between the base plate 310 and the swing plate 320, with the drives being opposite to each other, thereby providing a balance of swing operation.

FIG. 7 illustrates a mounting structure of the semi-automatic power drives 330 and 340 according to the preset invention. Referring to FIG. 7, the base plate 310 has mounting openings 313 and 314 to which each of the semi-automatic power drives 330 and 340 is mounted. The semi-automatic power drives 330 and 340 are rotatably mounted to the mounting openings 313 and 314. That is, each of the mounting openings 313 and 314 includes a tracing region of rotational displacement of the semi-automatic power drives 330 and 340. In addition, the semi-automatic power drives 330 and 340 are symmetrically placed around the opening 312, and are formed in a triangular shape. The mounting openings 313 and 314 penetrate the base plate 310.

Accordingly, each of the semi-automatic power drives 330 and 340 is mounted to the mounting openings 313 and 314, which is advantageous to a thin structure of the semi-automatic swing device according to the present invention.

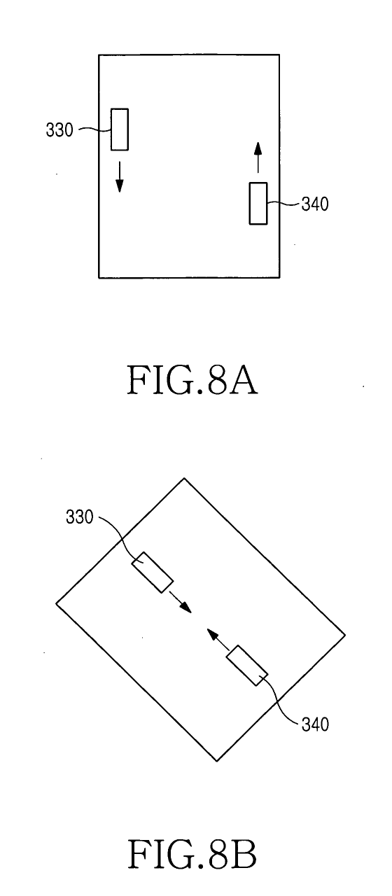

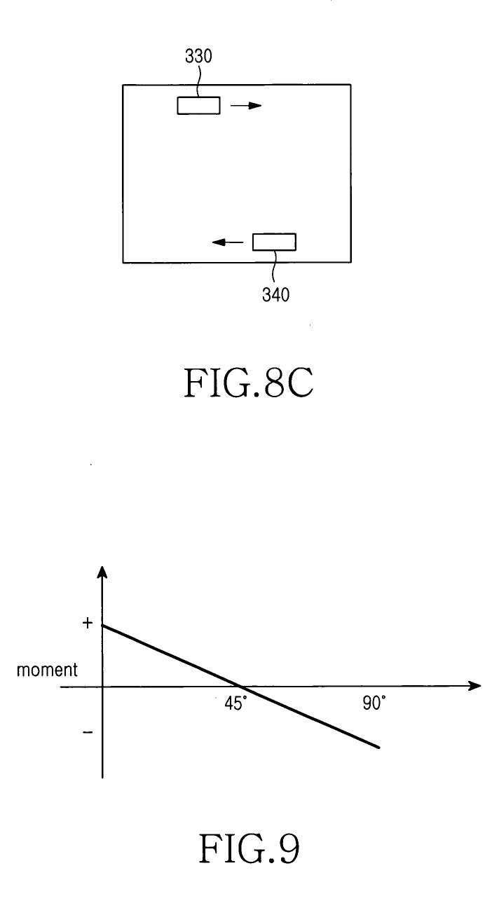

In FIG. 8A, if a user forcibly rotate the swing plate 320 to a certain angle, the semi-automatic power drive 330, i.e., both ends of the semi-automatic power drive 330, are rotated, and the rod member 332 is fitted in the hollow portion 331. Accordingly, the rod member 332 compresses the compression coil spring 333. Gradual swing operation of the swing plate 320 causes the rod member 332 to gradually draw in the hollow portion 331 and simultaneously the compression coil spring 333 gradually compress.

When the swing plate 320 is manually and continuously rotated above a certain angle, e.g., 45°, the drawn rod member 332 comes out of the hollow portion 331. The drawing force is resulted from a resilient force of the compression coil spring 333. The swing plate 320 pushes the rod member 332 towards the rotating direction of the rod member, and the swing operation is completed.

The semi-automatic power drive 340 is simultaneously operated similar to the semi-automatic power drive 330. Arrows illustrated in FIGS. 8A through 8C indicate a direction of the resilient force of the coil spring employed in the semi-automatic power drives 330 and 340.

Preferably, the tracing region of rotational displacement of the semi-automatic power drives 330 and 340 is contained in the mounting openings.

In addition, it is noted that the semi-automatic swing device of the present invention can adjust a critical angle by changing a pivot point of the semi-automatic power drives 330 and 340 pivotally mounted the base plate 310.

The semi-automatic power drive 330 provides the minimum resilient force when a rotational amount of the swing plate 320 is an angle of 0° or 90°. At that time, the compression coil spring 333 is maximally expanded. The semi-automatic power drive 330 does not provide any resilient force when a rotational amount of the swing plate 320 is an angle of 45°. At that time, the compression coil spring 333 is maximally compressed.

Referring to FIG. 9, in the range in which the swing plate 320 swings in an angle of 0° to 45°, i.e., a user applies a force to the swing plate, the swing plate 320 is applied with a positive moment force, and is then rotated in a counterclockwise direction. In the range in which the swing plate 320 swings in an angle of 45° to 90°, the swing plate 320 is applied with a negative moment force from the semi-automatic force drives 330 and 340 corresponding to the positive moment force, and is automatically rotated. The moment is zero at an angle of 45° of the swing plate.

The semi-automatic swing device of the present invention is not limited to that the semi-automatic driving force is provided by the resilient force of the spring and the principle of the moment, and may be applied to a pneumatic module. If an automatic swing device is embodied, a motor and a reduction module may be utilized.

In addition, the semi-automatic swing device of the present invention is easily assembled and is slimmer by virtue of the use a very simple straight spring module.

While the present invention has been shown and described with reference to certain preferred embodiments thereof, it will be understood by those skilled in the art that various changes in form and details may be made therein without departing from the spirit and scope of the present invention as defined by the appended claims.

What is claimed is:

1. A semi-automatic swing device for a mobile terminal comprising:
a base plate;
a swing plate rotatably mounted to the base plate; and
at least one semi-automatic power drive, which is interposed between the base plate and the swing plate, for applying a moment force to be rotated in a counterclockwise direction to the swing plate, if the semi-automatic power drive pivots up to a desired angle, and applying a moment force to be rotated in a clockwise direction to the swing plate, if the semi-automatic power drive pivots above a desired angle.

2. The semi-automatic swing device as claimed in claim 1, wherein the at least one semi-automatic power drive comprises a spring module having a coil spring.

3. The semi-automatic swing device as claimed in claim 1, wherein a first end of the semi-automatic power drive is rotatably fitted in the base plate, and a second end of the semi-automatic power drive is rotatably fitted in the swing plate.

4. The semi-automatic swing device as claimed in claim 1, wherein the at least one semi-automatic power drive is linearly expanded and contracted.

5. The semi-automatic swing device as claimed in claim 1, wherein the at least one semi-automatic power drive is placed opposite to another semi-automatic power drive.

6. The semi-automatic swing device as claimed in claim 1, wherein the semi-automatic power drive does not supply a power to the swing plate if a rotational angle of the swing plate is 45°.

7. The semi-automatic swing device as claimed in claim 1, wherein the at least one semi-automatic power drive is formed in a straight shape.

8. The semi-automatic swing device as claimed in claim 1, wherein the at least one semi-automatic power drive comprises:
a hollow portion having an invariable length for accommodating a spring therein; and
a rod member having a variable length, which is fitted in the hollow portion and expanded and retracted using the spring.

9. The semi-automatic swing device as claimed in claim 8, wherein the hollow portion and the rod member are made of metal.

10. The semi-automatic swing device as claimed in claim 1, wherein the base plate and the swing plate are each formed with a circular opening at a center thereof, respectively.

11. The semi-automatic swing device as claimed in claim 10, wherein a pair of the semi-automatic power drives are symmetrically placed around the opening, and one of the pair of semi-automatic power drives is mounted in a reversed shape to the other of the pair of semi-automatic power drives.

12. The semi-automatic swing device as claimed in claim 1, wherein the base plate comprises a mounting opening to which the at least one semi-automatic power drive is mounted.

13. The semi-automatic swing device as claimed in claim 12, wherein the mounting opening comprises a tracing region of rotational displacement of the at least one semi-automatic power drive.

14. The semi-automatic swing device as claimed in claim 1, wherein the at least one semi-automatic power drive adjusts a critical angle by changing a pivot point of the at least one semi-automatic power drive.
